(19) United States
(12) Patent Application Publication
(10) Pub. No.: US 2014/0239721 A1
(43) Pub. Date: Aug. 28, 2014

(54) ELECTRIC POWER SYSTEM FOR ELECTRIC DEVICES

(71) Applicant: GREENPRIZ, La Colle sur Loup (FR)

(72) Inventor: Eric Sgarroni, Gattieres (FR)

(21) Appl. No.: 14/352,595

(22) PCT Filed: Oct. 17, 2012
(86) PCT No.: PCT/EP2012/070596

§ 371 Date: Apr. 17, 2014

(30) Foreign Application Priority Data
Oct. 18, 2011 (FR) 11 59415

(51) Int. Cl. H02J 3/00

(52) U.S. Cl. CPC H02J 3/00
USPC 307/38

(57) ABSTRACT

The present invention concerns an electrical supply system for electrical apparatus, comprising at least one master electrical socket, referred to as the primary master socket, able to be connected between an electrical supply source and at least one electrical apparatus. The system is characterised in that the primary master socket comprises: connection means to a user terminal or to a data storage means configured so as to receive a plurality of computerised calendars; data storage means able to store the plurality of computerised calendars; transmission means configured so as to transmit at least one computerised calendar to another electrical socket. The primary master socket further comprises control means associated with a processor and configured so as to enable or interrupt the supply to the electrical apparatus able to be connected to the primary master socket according to a computerised calendar stored in the data storage means.

### TECHNICAL FIELD OF THE INVENTION

The present invention concerns an electrical supply system.

More particularly, the application of the invention is environments in which a plurality of electrical apparatus are supplied with electricity by a supply network and in which it is wished to control the time ranges of electrical supply of these electrical apparatus.

### PRIOR ART

Constantly growing, electricity consumption in France mainly relates to dwellings and the tertiary sector. Studies have shown that approximately 66% of the total amount of electrical energy consumed each year comes from dwellings, 27% from industry, and only 2.7% is consumed by the steel industry, 1.6% by agricultural and 2.9% by urban and rail transport.

A major part of the consumption of electricity in dwellings and in business environments stems from electrical apparatus such as for example computers, air conditioning, computer peripherals such as printers and scanners, drinks or snacks dispensers, dynamic display screens and other video and audio apparatus. These apparatus are often left in a standby state but still remain connected to the electric current sockets. Even in a standby state, electricity consumption remains substantial. In general, for example, an LED television set on standby may consume from 0.5 up to 4 W.

Often the electrical apparatus are placed between or on items of furniture that cover the electric sockets. It is therefore difficult to disconnect the supply socket when it is wished to physically interrupt the electrical supply to the apparatus.

There exist solutions in which electrical switches are connected to the main switch of each dwelling. These electrical switches are installed when the electrical network of the house is created and make it possible to physically deactivate the electrical supply of a subgroup of electrical apparatus. Thus, in a business environment, it is possible for example to deactivate the lighting system and the computer equipment of the workstations of the employees in order to reduce the electricity consumption of the screens, without switching off the servers. In retail outlets or places where perishable goods are stored, it is possible for example to deactivate the lighting system on the computer equipment while leaving the refrigerating equipment connected. In a domestic environment, it is possible for example to deactivate the apparatus connected in the living room while leaving the kitchen apparatus connected, in order to reduce the consumption of electricity due to the television set in the living room without switching off the refrigerator in the kitchen.

There exist solutions in which multisocket units enable several apparatus to be activated or deactivated, by manual pressure on a button on the multisocket unit.

The known multisocket units and switches always have the drawback of not making it possible to automatically manage the times when the electrical apparatus are to be activated. This operation must be performed by hand, whenever the apparatus is to be activated or deactivated.

The patent US 2004/0051393 teaches a plurality of options (activation for the entire day, always activated, always deactivated, addition or subtraction of one hour) in order to manage and programme the activation of a plurality of electronic apparatus.

The document US 2011/0062780 teaches the presence of a slave socket in an electrical power distribution unit.

Though the known solutions make it possible to individually manage each of the sockets, the fact nevertheless remains that it would be advantageous to propose a solution for simply deploying, managing and extending at limited cost a set of electrical sockets, each of these sockets being able to cut off or enable the electrical supply to an electrical apparatus that is associated therewith.

The present invention aims to propose a solution for achieving at least one of the above objectives.

### SUMMARY OF THE INVENTION

The subject matter of the present invention is an electrical supply system for electrical apparatus, comprising at least one master electrical socket, referred to as the primary master socket, able to be connected between an electrical supply source and to at least one electrical apparatus. The primary master socket comprises means of connection to a user terminal and/or to a removable data storage means configured so as to receive a plurality of computerised calendars. It also comprises data storage means, typically a memory, able to store the plurality of computerised calendars. In addition, it comprises transmission means configured so as to transmit at least one computerised calendar to another electrical socket. The primary master socket further comprises control means associated with a processor and configured so as to enable or interrupt the supply to the electrical apparatus able to be connected to the primary master socket according to a computerised calendar stored in the data storage means.

Thus the present invention makes it possible to transmit computerised calendars between several sockets. A single calendar may be dedicated to each socket and therefore potentially to each electrical apparatus. The invention avoids having to connect each of the sockets with a user terminal for programming the activation and deactivation ranges. A network of sockets can thus be deployed easily, quickly and at a considerably limited cost. In addition, the extension of an existing network is done particularly easily, since it suffices for the additional sockets, controlling newly installed electrical apparatus, to be able to receive from a primary master socket a calendar relating to these newly installed electrical apparatus. The invention thus simplifies the integration, within a network of existing sockets, of new electrical apparatus each controlled by a socket.

Optionally, the system according to the invention may have at least any one of the following optional features:
Said other electrical socket is an extension socket, referred to as the secondary master socket, able to be connected between an electrical supply source and at least one electrical apparatus, the extension socket or secondary master socket comprising reception means configured so as to receive at least one computerised calendar sent by a primary master socket, data storage means able to store at least one computerised calendar received and control means associated with a processor and configured so as to enable or interrupt the supply to the electrical apparatus connected to the secondary master socket according to a computerised calendar stored in the data storage means of this secondary master socket.
In the present description, master socket means a socket that can transmit to a slave socket a command for activating or deactivating the electrical apparatus associated with the slave socket. The designation master socket includes the primary and secondary sockets. The difference between these two types of socket is the presence of means of connection to a user terminal and/or to a removable data storage means. Thus the secondary master sockets fulfil a function of relay of the computerised calendars. They thus make it possible to extend an existing network of sockets without having to provide multiple connections and other additional wirings between sockets to be added and a primary master socket. Thus the network can easily be extended while the means of communication between the sockets have relatively short ranges.
The data storage means of the primary master socket contain a first calendar for this primary master socket and at least a second calendar for a secondary master socket.
The system comprises at least one slave socket able to be connected between an electrical supply source and an electrical apparatus, the slave socket comprising reception means configured so as to receive, from a primary master socket or a secondary master socket, a command for activating or interrupting the electrical supply of the electrical apparatus associated with this slave socket.
The master socket is a primary master socket.
The master socket is a secondary master socket, the secondary master socket comprising means of transmitting said command to the slave socket. Thus the slave socket does not need to comprise data storage means. The master socket in charge of this slave socket reads the calendar of the latter and sends it an activate or interrupt command when this calendar indicates that the electrical apparatus associated with the slave socket must be connected to or respectively disconnected from the electrical supply.
Advantageously each socket, master or slave, is associated with a separate electrical apparatus.
Advantageously the sockets are distant from one another.
Typically, the user terminal is a terminal comprising a user interface for selecting or defining partly at least one computerised calendar. The user terminal may be a personal computer, a personal digital assistant (PDA), a mobile telephone, a graphics tablet or any dedicated apparatus.
At least one socket comprises a module for reading electricity consumption configured so as to read the electricity consumption of the apparatus, connected to said socket. Preferably each socket comprises such a reading module. It is thus possible to have a precise history of the consumption for each electrical apparatus.
The slave socket is configured so as to transmit, to at least one primary master socket, electricity consumption data read by the reading module of this slave socket.
The secondary master socket is configured so as to transmit, to at least one primary master socket, electricity consumption data read by the reading module of this secondary master socket.
The primary master socket is configured so as to transmit the electricity consumption data to a user terminal to which this primary master socket is connected continuously or at isolated points.
At least one socket comprises means for forcing the electrical activation, these forcing means being able to be actuated by a user. Preferably the forcing means comprise a button conformed so as to inhibit the command that depends on the computerised calendar. Advantageously the user of the electrical apparatus can thus disregard the deactivation of the electrical apparatus by the calendar associated with this electrical apparatus. Preferably, the socket accepts a forced triggering configuration when the button is pressed independently of the calendar.
At least one socket can be configured by a user according to several activation extension modes. Typically, when the planned time of interruption of the supply approaches, the user can decide to extend the duration of activation for a period taken from a choice of predetermined periods or for a period that is entered.
At least one socket comprises a signalling means configured so as to signal an imminent deactivation of the electrical supply. Typically, before the time provided for by the calendar for the suppression of the supply, a visual or audible signal is emitted. The user is thus alerted that the supply will be interrupted in a very short time. He can thus either terminate his activity before the planned interruption time, or trigger the forcing means.
Each socket comprises reception and transmission means configured so as to transmit and receive data to/from the remote master sockets. Typically, these other sockets are primary master sockets and/or secondary master sockets.
At least one master socket comprises a time reference stage configured so as to maintain a synchronisation of the date and time of this master socket with the date and time of the user terminal. Preferably, each master socket comprises the time reference stage. A primary master socket adjusts its time data over the user terminal. Advantageously, it transfers this time reference to the secondary master sockets.
The synchronisation is effected on a reference clock external to the socket.
The means of connecting at least one primary master socket comprise a connection port for connection with said user terminal. Alternatively or in combination, the means of connection of at least one primary socket comprise a connection port for connection with a removable data storage means in order to receive said plurality of computerised calendars. Typically, the communication port is a port of the USB (universal serial bus) type and the removable data storage mean is a USB key.
At least one socket comprises means for limiting the electric current delivered to the electrical apparatus.

According to another embodiment, the invention concerns an electrical supply system for electrical apparatus comprising at least one master electric socket, referred to as the primary master socket, comprising means for connection to a user terminal and/or to a removable data storage means configured so as to receive a plurality of computerised calendars. It also comprises data storage means, typically a memory, able to store the plurality of computerised calendars. Furthermore, it comprises transmission means configured so as to transmit at least one computerised calendar to another electrical socket.

All the optional features mentioned above can be combined with the embodiment in the previous paragraph.

Preferably but optionally, the master socket is able to be connected between an electrical supply source and at least one electrical apparatus. The primary master socket also comprises control means associated with a processor and configured so as to enable or interrupt the supply to the electrical apparatus able to be connected to the primary master socket according to a computerised calendar stored in the data storage means.

Another subject matter of the present invention concerns a modular electrical supply system for electrical apparatus, comprising at least one extension master socket, also referred to as the secondary master socket. This secondary master socket is able to be connected between an electrical supply source and at least one electrical apparatus. It comprises: reception means configured so as to receive at least one computerised calendar, for example from another electrical socket; data storage means able to store the at least one computerised calendar; control means associated with a processor and configured so as to enable or interrupt the supply to the electrical apparatus in which the secondary master socket is able to be connected according to at least one computerised calendar stored in the data storage means. Thus this secondary master socket or extension master socket does not need to be able to be reached by the user terminal. To extend the network, from an existing primary master socket, a secondary master socket can easily be added in order to control additional electrical apparatus.

Optionally, the system according to the invention may have at least any one of the following optional features:
The secondary master socket is configured so as to store at least one computerised calendar relating to a slave socket and to send to this slave socket a command for activation or interruption of the electrical supply to an electrical apparatus able to be connected to this slave socket according to the computerised calendar relating to this slave socket.
The system comprises at least one slave socket able to be connected between an electrical supply source and an electrical apparatus, the slave socket comprising reception means configured so as to receive from the secondary master socket a command activating or interrupting the electrical supply.
The system comprises a transmission module comprising: means of connection to a user terminal and/or to a removable data storage means, these connection means being configured so as to receive a plurality of computerised calendars; transmission means configured so as to transmit at least one computerised calendar to the secondary master socket.
The secondary master socket and the transmission module are distant.
According to an advantageous alternative, the transmission module is a so-called primary master socket, able to be connected between an electrical supply source and at least one electrical apparatus, the primary master socket comprising: data storage means able to store the plurality of computerised calendars received from the user terminal and/or from the removable data storage means; transmission means configured so as to transmit at least one computerised calendar to the secondary master socket; control means associated with a processor and configured so as to enable or interrupt the supply to the electrical apparatus to which the primary master socket is connected according to a computerised calendar stored in the data storage means.
To enable or interrupt the supply to the electrical apparatus, the secondary master socket receives only computerised calendars from the primary master socket. It does not receive an activation/deactivation command to be executed on reception of such commands.

According to another aspect, the subject matter of the invention is a modular electrical supply system for electrical apparatus, comprising at least one master electric socket, referred to as the primary master socket, able to be connected between an electrical supply source and at least one electrical apparatus, characterised in that the master socket comprises means of connection to a user terminal and/or to a removable data storage means, configured so as to receive a plurality of computerised calendars, data storage means able to store the plurality of computerised calendars, transmission means configured so as to transmit at least one computerised calendar to another electric socket ale to store this at least once computer calendar and able to be connected between an electrical supply source and at least one electrical apparatus, at least one from the primary master socket and the other socket comprising control means associated with a processor and configured so as to enable or interrupt the supply to the electrical apparatus, to which it is connected according to a computerised calendar stored in the data storage means.

Another subject matter of the invention is a method for managing a plurality of sockets forming part of an electrical supply system for electrical apparatus, each socket being electrically connected between an electrical supply source and at least one electrical apparatus, the method being characterised in that it comprises the transmission of at least one computerised calendar from a primary master socket belonging to the plurality of sockets to another socket among the plurality of sockets.

Optionally, the method according to the invention may have at least any one of the following optional steps and features:
The at least one computerised calendar is transmitted from a primary master socket to a secondary master socket belonging to the plurality of sockets and in which the at least one computerised calendar is stored in data storage means of the secondary master socket.
Advantageously, said other socket and the primary master socket are distant.
According to a variant embodiment, the at least one computerised calendar relates to the secondary master socket and in this secondary master socket activates or deactivates the electrical supply to the electrical apparatus to which it is connected according to said computerised calendar.
According to another variant embodiment, the at least one computerised calendar relates to a slave socket and the secondary master sockets sends to the slave socket a command to activate or interrupt the electrical supply according to say computerised calendar.
The primary master socket transmits an activate or deactivate command to a slave socket of the electrical supply system.
The slave socket, on receiving said command, activates the electrical supply to the electrical apparatus if the command is an activate command or deactivates the electrical apparatus if the command is a deactivate command.
The method comprises a step of storing a plurality of computerised calendars in the storage means of the primary master socket and comprises, before the storage step, a step of transmitting the computerised calendars from a user terminal connected to the primary master socket.
The method comprises a step of transferring electricity consumption data from the electrical apparatus to the primary master socket.
The electricity consumption data are transmitted from the primary master socket to a user terminal connected to said primary master socket and/or to a removable data storage means connected temporarily to said primary master socket.

### BRIEF DESCRIPTION OF THE FIGURES

The aims, objects, features and advantages of the invention will emerge more clearly from the detailed description of an embodiment of said invention that is illustrated by the following accompanying drawings, in which:

FIG. 1 illustrates an overall view of a modular electrical supply system for electrical apparatus according to the present invention.

FIG. 2 illustrates a diagram of the commands that can be exchanged between two sockets forming part of the system according to the present invention.

FIG. 3 is a schematic representation of a master socket designated as the primary master socket according to an example embodiment of the invention.

FIG. 4 is a schematic representation of a master socket designated as the secondary master socket, or extension socket, according to an example embodiment of the invention.

FIG. 5 is a schematic representation of a socket designated as a slave socket according an example embodiment of the invention.

FIG. 6 is a schematic representation of a sequence of steps for adding calendars or updating calendars and/or network parameters from a removable data storage means such as a USB key.

FIG. 7 is a schematic representation of a sequence of steps for recovering consumption data on a removable data storage means such as a USB key that is connected to a primary master socket.

The accompanying drawings are given by way of examples and are not limitative of the invention.

### DETAILED DESCRIPTION OF THE INVENTION

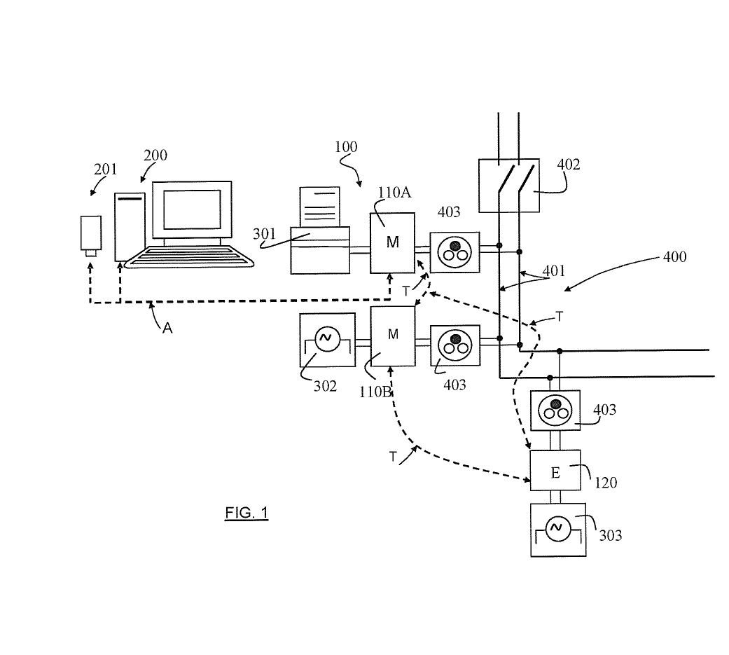

FIG. 1 illustrates an overall view of a modular electrical supply system 100 for electrical apparatus 301-303.

The electrical apparatus are for example placed in a building, such as for example a dwelling, in which there is an electrical network 400 comprising a plurality of electric wires 401. Typically in a domestic environment these wires are two in number and the electric current is alternating and two-phase. The system according to the present invention can also be used in an industrial environment with a three-phase current at 380 V for example. The electric wires 401 are connected to a master switch 402, which makes it possible to deactivate the electrical supply to the network 400 when a user so requires.

A plurality of wall sockets 403 are connected to the electric wires 401 to make it possible to connect a plurality of electrical apparatus 301-303 such as domestic electrical apparatus, audio and video equipment, computer equipment, air conditioning equipment, etc.

Advantageously, the system according to the present invention comprises at least one primary master socket 110A installed between an electrical apparatus 301 and a wall socket 403. In detail, the primary master socket 110A comprises a plug able to be connected to the wall socket 403, and a plug able to be connected to the supply of the electrical apparatus 301 by means of a supply lead for example.

The primary master socket 110A also comprises an input, capable of being connected to a user terminal 200 which, according to FIG. 1, is shown in the form of a computer, but which may also be a mobile telephone, a smartphone, a graphics tablet or a dedicated box. More generally, the user terminal comprises a user interface, means for entering, programming or selecting data and means for transmitting these data.

Alternatively or combined with a port for communication with a user terminal, the primary master socket 110A may comprise a port for communication with a removable data storage means, typically a removable memory. A removable data storage means is equipment that a user can physically connect to the master socket. A typical example of a removable data storage means is a USB key.

In FIG. 1, the removable data storage means and the terminal are shown under the references 201 and 200 respectively. The transmission and reception of the data between the primary master socket 110A and the user terminal 200 or the removable data storage means 201 is shown with hatched arrow A. In the remainder of the description, for reasons of concision and clarity, reference will mainly be made to the embodiment in which the computerised calendars are transmitted from the user terminal 200. Nevertheless, all the features mentioned for this embodiment are also applicable to the embodiment in which the computerised calendars are transmitted from the removable data storage means 201.

The primary master socket 110A comprises a memory able to store data and in particular to store a plurality of the computerised activation and deactivation calendars transmitted by the user terminal 200.

Each computerised calendar may comprise a time division, not only for a complete day but also for each minute of the day over a plurality of years. These computerised calendars define ranges for activation/deactivation of the electrical apparatus with respect to the electrical supply.

Thus, for each time subdivision of the calendar, the calendar comprises a command for activation (for example a 1 bit) or deactivation (for example a 0 bit) of the electrical supply to the electrical apparatus. Thus, at a certain time, the primary master socket 110A, on its computerised calendar, finds a command 1 and activates the supply to the electrical apparatus connected; on the other hand when the command changes from the 1 state to 0, it deactivates the supply to the electrical apparatus connected.

The primary master socket 110A can store in its memory several activation calendars intended for a plurality of sockets, as described below.

Preferably the primary master socket 110A can also store in the memory 110 the consumption of the electrical apparatus 301 connected.

Advantageously, the system 100 also comprises secondary master sockets 110B also referred to as extension master sockets. These secondary master sockets 110B are differentiated from the primary master socket 110A through the fact that they comprise fewer means of connection to the user terminal 200. Each secondary master socket 110B nevertheless comprises reception means 110e configured so as to receive at least one computerised calendar sent by the primary master socket 110A.

As with the primary master socket 110A, the extension secondary master socket 110B is also installed between an electrical apparatus 302 and a wall socket 403 and comprises a plug able to be connected to the wall socket 403, and a plug able to be connected to the plug of the supply lead of the electrical apparatus 302. Thus the system 100 comprises several master sockets 110, at least one of the master sockets being a primary master socket 110A and at least one other of these master sockets 110 being a secondary master socket 110B. In the remainder of the description the reference 110 is used to designate both a primary master 110A and secondary master socket 110B.

Thus each primary master socket 110A is directly connected to the user terminal 200 continuously or at isolated points in time. Moreover, it comprises, in addition to the memory already discussed, a transceiver 110e for retransmitting digital data and, in particular, computerised calendars for activating/deactivating the electrical apparatus.

The transmission and reception of the data between the master sockets 110A, 110B is indicated with the hatched arrows T.

The system according to the present invention also comprises one or more slave sockets 120, which are differentiated from the master sockets 110 in particular in that they do not have any memory for storing the computerised calendars. They are configured so as to receive commands for activating and deactivating the electrical apparatus 303 that are connected to them. These commands are sent to them by the master sockets 110A, 110B. The slave sockets 120 can also transmit consumption data to a master socket 110A, 110B. As with the master sockets 110, the slave sockets 120 also comprise a transceiver stage for receiving in general the digital data and, in particular, the activation calendars and optionally for transmitting electricity consumption data.

The data exchanges between the primary master sockets 110A, secondary master sockets 110B and slave sockets 120 can advantageously be done in accordance with any one of the known communication technologies, preferably wireless, Bluetooth, ZigBee, IEEE 802.15.4-2006, Wireless USB, UWB etc or a proprietary protocol or by means of a cabled network, for example PLC (Power-Line Communication, the principle of which consists of superimposing, on the alternating electric current, a signal at a higher frequency and lower energy). These technologies have the advantage of offering good modularity of the system 100 without having cables laid in the dwelling for transmitting and receiving the calendars between the master sockets 110.

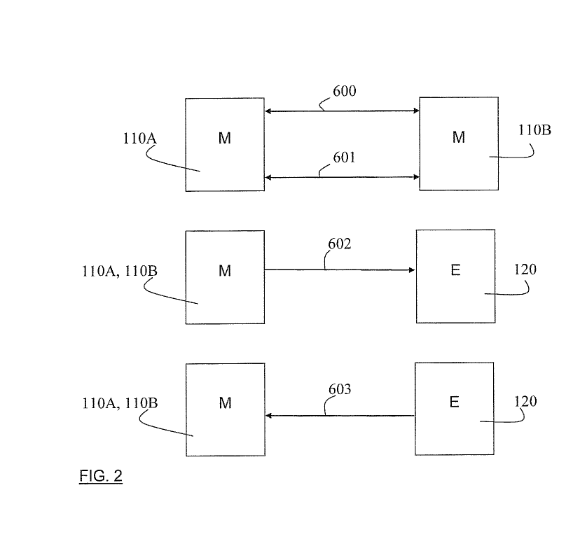

FIG. 2 summarises the typologies of the commands that the various sockets can exchange. In more detail, between two master sockets 110A, 110B, it is possible to exchange computerised activation calendars the transmission of which is indicated with a double arrow 600.

Moreover, between two master sockets 110A, 110B, it is possible to exchange electricity consumption data 601. These electricity consumption data exchange between a secondary master socket 110B and a primary master socket 110A relate to the consumption of the electrical apparatus, either associated with this secondary master socket 110B, or associated with another second master socket 110B capable of exchanging (sufficiently close for example) with the secondary master socket, or associated with a slave socket 120. The transmission is at the same hierarchy level and can therefore arrive at any one of the primary master sockets 110A.

Between a master socket 110A, 110B and a slave socket 120, it is possible to have two message typologies. The first typology consists of the messages demanding activation or deactivation of the slave socket 120, which are sent by a master socket 110A, 110B at the moment when the calendar that the latter stores in its memory identifies, for the slave socket in question, an activation or deactivation command. Thus the sending of the activation or deactivation commands from a master socket 110 to a slave socket 120 corresponds to the moments where there is a change of state of the computerised calendar dedicated to the slave socket 120. The messages commanding activation or deactivation of the slave socket 120 can therefore be known as state-change messages 602 of a slave socket 120. A slave socket 120 cannot send this type of message, but only receive it. For this reason, in FIG. 2, the arrow has only one direction in the direction of the slave socket 120.

The second typology is formed by the electricity consumption data 603 that are transmitted from the slave socket 120 to a master socket 110A, 110B; the electricity consumption data cannot be transmitted to the slave sockets since they remain at a lower (or subordinate) hierarchical level with respect to the master sockets 110A, 110B.

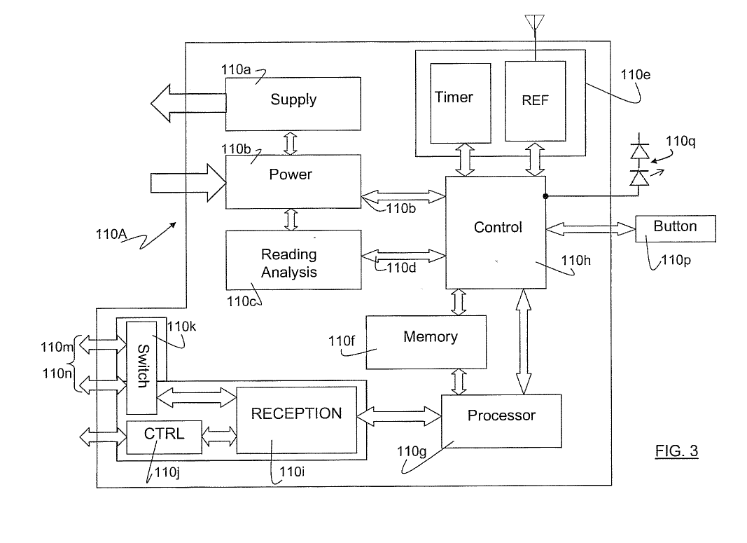

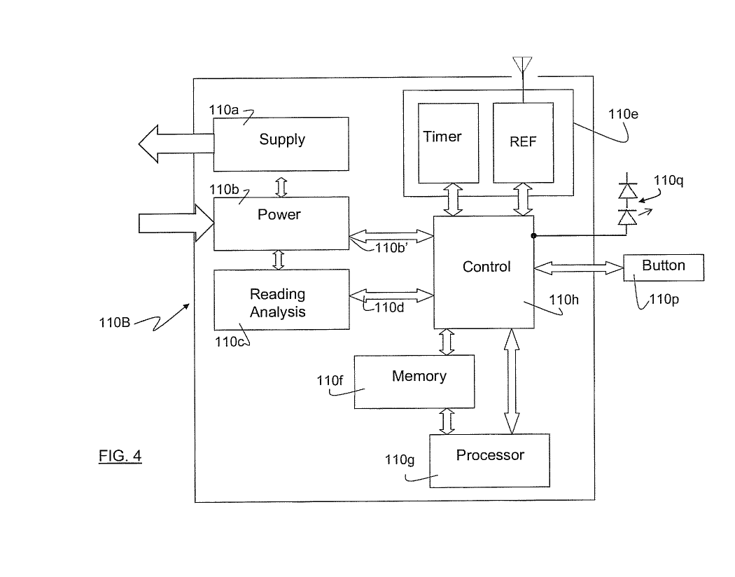

FIGS. 3, 4 and 5 show in more detail the respective structures of each primary master socket 110A, secondary master socket 110B and slave 120.

The primary 110A and secondary 110B master sockets comprise:
A supply stage 110a, which is connected to the electrical network 400 by means of the wall socket 403.
A power circuit 110b, comprising an input electrically connected to the supply stage 110a and which acts so as to activate the supply when an activation signal is sent on its control input 110b.
An electricity consumption reading module 110c, which comprises an input electrically connected to the power circuit 110b and an output 110d carrying digital data representing electricity consumption (for example in watts/h), which passes through the power circuit 110b). This module preferably also makes an analysis of these readings.
A transceiving stage 110e, which comprises a radio communication (or radio-frequency communication) module to which at least one antenna is electrically connected.

Preferably but optionally, the master socket 110 also comprises a transmission calendar module designed so as to determine when it is necessary to send the consumption data to the master socket 110.
Data storage means 110f forming a storage stage, of the non-volatile type, in which the activation calendars are saved.

Since the storage stage is non-volatile, in the event of the current being cut off, the data will remain stored on the socket and will therefore be effective as soon as the power supply on the electric network is re-established.
An electronic unit for producing the data, or processor 110g, designed to execute all the processes that are necessary for the functioning of the master socket 110.
A control unit 110h, comprising a plurality of ports to which the processor 110g, the data storage means 110f, the transceiving stage 110e, the electrical consumption reading module 110c and the power circuit 110b are electrically connected.

When the calendar associated with the master socket 110 in question arrives at a change of state from the activated position to the deactivated position or vice versa, the control unit 110h transmits an activation command to the control input 110b of the power circuit 110b.

The primary master socket 110A, as explained above, also has the possibility of being connected to a user terminal 200 such as a computer. Thus the primary master socket 110A is differentiated from the extension secondary master socket 110B in that it also has a stage 700 for communication to a computerised network.

As shown in FIG. 3, the communication stage 700 of the primary master socket 110A comprises a stage for receiving data 110i, electrically connected to the processor 110g. It also comprises a control stage, equipped for example with a USB port 110j, connected to the processor 110g and allowing an exchange of data to the user terminal 200. It also comprises an interrupt circuit 110k that enables data to be exchanged to the computer 200 via Ethernet ports 110m, 100n.

In detail, the USB socket 110j makes it possible to receive for example a USB key containing the various calendars of the sockets 110A, 110B, 120 of the system 100. Each socket is in this case programmed individually.

The Ethernet ports 110m, 100n are used to connect the primary master socket 110A with a user terminal 200, with the purpose of being able to receive the configuration information and data on the operating time ranges of the sockets or activation calendars. The ports are preferably two in number so as to make it possible, when the socket is used with an apparatus using the Ethernet network (for example a printer), to connect this apparatus to the network by means of a first port and to keep a port available for connecting the primary master socket 110A with a user terminal for control and monitoring of the electrical apparatus. The Ethernet ports of the socket make it possible to receive and transmit data in Mbit/s, by means of Ethernet controller, for example 10/100 base T.

The timing module also enables each master socket 110 to keep the date and time up to date. Whenever the primary master socket 110A is connected to a user terminal 200, synchronisation will be done in order to prevent clock drifts. This synchronisation can then be retransmitted to the secondary master sockets 1108.

Typically, it is a network time protocol, a protocol the makes it possible to synchronise the local clock (in this precise case of the socket), via a computer network, on a reference time (in this case the computer 200) or an external reference. For example, if the user terminal 200 is connected to the Ethernet, the external reference may consist of a NTP server that is typically connected directly to a reference clock.

Finally, the master socket 110, whether it be primary or secondary, comprises an activation button 110p and a signalling means indicating the state of the socket. The signalling means is for example an LED 110g situated on a front face of the socket, in particular the front face that remains visible once the socket is connected to the wall socket 403. The LED 110g indicates whether the socket is on or off or to indicate an alert range before switching off thereof to enable the user to prolong the use of the socket by pressing the activation button 110p and to also indicate any malfunction.

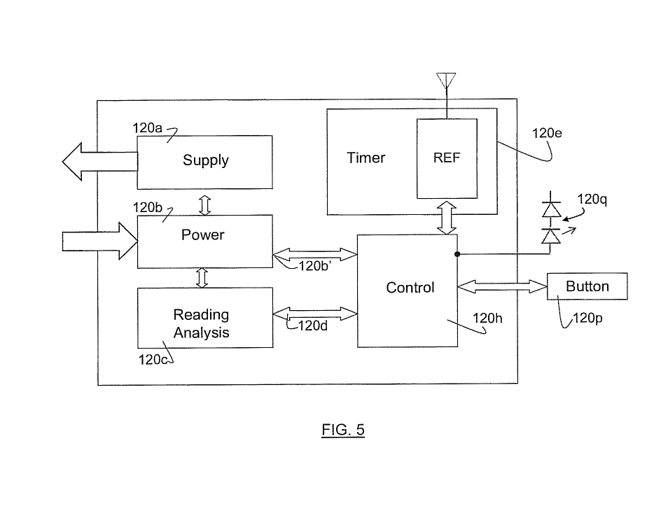

FIG. 5 illustrates a schematic representation of a slave socket 120 according to the present invention.

The slave socket 120 comprises:
a supply stage 120a, which is connected to the electrical network 400 and in particular to the wall socket 403;
a power circuit 120b, comprising an input electrically connected to the supply stage 120a and which acts so as to activate the supply when an activation signal is sent to its control input 120b′;
an electricity consumption reading module 120c, which comprises an input electrically connected to the power circuit 120b and an output 120d carrying digital data representing electricity consumption (for example in watts/h passing through the power circuit 120b);
a transceiving stage 120e that comprises a radio communication (or radio-frequency communication) module, to which at least one antenna is electrically connected for transmitting data to master sockets 110A, 110B;
a control unit 120h, comprising a plurality of ports to which the transceiving stage 120e, the electricity consumption reading module 120c and the power circuit 120b are electrically connected. On the ports of the control unit 120h, the control data are exchanged between the units and the stages of the slave socket 120.

As for the master sockets 110A, 110B, the slave socket 120 comprises an activation button 110, and an LED 110q or any other signalling means indicating the state of the socket. Here again, the LED indicates whether the socket is on or off, indicates an alert range before the switching off of the socket in order to give the user the possibility of prolonging the use of the socket by pressing the activation button 110p, and also indicates any fault.

The slave socket 120 is therefore differentiated from the master sockets 110A, 110B through the fact that it does not have any memory, or a processor, or a stage 700 for communication to a computerised network. It is therefore considerably simplified and less expensive than a master socket 110A, 110B. It can therefore be deployed in large numbers.

The system according to the present invention is preferably designed so as to enable a single primary master socket 110A to transmit data to software for managing the system 100 stored in the memory of the user terminal 200.

The management software of the system 100 makes it possible to configure the transmission calendar for the consumption data of each socket. For this reason, each socket has a time established at which a transmission of the daily consumption data will take place. Preferably, but not limitatively, this transmission will take place off-peak.

The transmission of the daily consumption data is subject to interrogation by the software which, via the primary master socket 110A connected to the user terminal 200, transmits commands to send the daily consumption data in turn to each socket. In detail, each command for sending the daily consumption data transmitted by the primary master socket 110A mentioned above is received at the transceiving stage 110e, 120e by means of the antenna that is electrically connected to the radio communication module.

According to one embodiment, in the event of the current being cut off, any data not downloaded onto the software will be lost.

The calendar configuration software makes it possible to manage all the calendars on a site and preferably the calendars of each of the primary 110A, secondary 110B and slave 120 sockets on a site. Site means the dwelling of a private individual, the premises of a business or for example a teaching establishment.

Each master 110 or slave 120 socket is associated with a computerised calendar for the electrical apparatus to which it is connected, this calendar defining the operating ranges of this apparatus. In return, a status is displayed in the software. The user chooses the calendars to be stored in each of the sockets.

When a large number of sockets is installed per site or per dwelling, it becomes necessary to be able to configure the sockets of the system 100 in groups. The configuration software thus makes it possible to define groups of sockets in accordance with a sorting by geographical location or by typology of electrical apparatus 302 connected or, in the case where the system 100 is installed in a business, by work sector (for example sales, production, distribution, research and development).

In summary, each socket in the system, either primary master 110A, or secondary master 110B or slave 120, can function in accordance with the following modalities:
functioning controlled according to the programmed calendar
forced triggering functioning, when a user forces the activation of the electrical utility by pressing the activation key 110p, 120p
prolonging-of-use functioning, where, at the time when the LED signals the imminent switching off of the socket, pressing the activation key 110p, 120p can delay the deactivation of the socket and therefore the cutting off of the electric current to the electrical apparatus to which it is connected.

In addition, with regard to the transfers of the data from the sockets 110A, 110B, 120 from the system 100 to the software:
the primary master socket 110A that is connected to the user terminal 200 sends the activation and deactivation status of the sockets to the software;
each extension master socket 110B sends the activation and deactivation statuses of itself as well as of the slave sockets 120 that it controls to the primary master socket 110A that is connected to the user terminal 200;
each extension master socket 110B sends the electricity consumption data of itself as well as of the slave sockets 120 that it controls to the primary master socket 110A that is connected to the user terminal 200;
the slave sockets 120 send only the consumption data to a primary master socket 110A directly by means of a secondary socket 120.

Thus, in addition to collecting consumption data, the user terminal 200 makes it possible to easily control the status of the sockets and consequently whether the apparatus are in their appropriate operating state. A user can thus easily detect that an apparatus is not supplied whereas it should be or is supplied when it should not be.

In practice, the invention proposes the following steps. A user defines, through a user terminal, operating ranges for each socket connecting an electrical apparatus to a supply network. It thus defines a computerised activation calendar for each socket. The primary master socket receives calendars through each of its ports connected to the terminal or by Bluetooth for example. It stores them in its memory. It sends the computerised calendars of the secondary master sockets and the computerised calendars of the slave sockets to the secondary master sockets, which save them. Each secondary master socket thus saves the calendar associated with the electrical apparatus to which it is connected as well as the calendars of the slave sockets controlled by this secondary master socket. The secondary master sockets send to the slave sockets the activation/deactivation commands at the times indicated on the calendars of these slave sockets. According to an advantageous embodiment, the secondary master sockets collect the consumption data from the slave sockets and transfer to the primary master socket the consumption data of the slave sockets as well as their own consumption data. If new sockets are installed on the network, it suffices to define new calendars via the user terminal and these new sockets, secondary master or slave, will automatically be controlled by their computerised calendars.

Thus, the invention proposes a simple solution for installing and extending a network of sockets. For example, in places selling or storing perishable goods, it is for example possible to deactivate the lighting system and the computer equipment while leaving the refrigerating equipment connected. All the operating ranges can be defined in a centralised manner. In these environments, it is possible to make provision for once again supplying the apparatus disconnected during the night a short time before the arrival of the employee so as to accelerate the startup of the day.

Finally, it should be noted that advantageously each power circuit 110b, 120b can be limited in terms of current supplied. For example, it will be possible to have a limitation at 16 A, in order to prevent a short-circuit risking damaging the socket.

According to a more general variant embodiment, the secondary master socket 110B receives the computerised calendars from a transmission module. The latter may be a primary master socket 110A but it may also be a module not making it possible to block or enable the electrical supply to an electrical apparatus. The function of this module may thus be reduced to the reception of computerised calendars from a user terminal 200 and the transmission of these calendars to the extension sockets 110b. This module may possibly control slave sockets. Optionally, this module may request, receive, retransmit and optionally analyse electricity consumption data.

Variant embodiments, already previously mentioned, will now be described in more detail. These variants may be combined with the embodiments described above in which the primary master socket 110A communicates with a user terminal 200.

According to these variants, the primary master socket 110A comprises at least one port for communication with a removable data storage means such as a USB key, the USB key being a non-limitative example.

Thus the slave master socket 110A may receive computerised calendars or network parameters from the removable data storage means after having inserted the latter in the dedicated port.

Moreover, the primary master socket 110A can transmit, to the removable data storage means, consumption data coming from the primary master socket 110A and preferably also secondary master sockets and safe sockets.

Particularly advantageously, this variant embodiment makes it possible to dispense with the need to have a user terminal within range of the primary master socket 110A or to have a server within the range of the primary master socket 110A for connection with a user terminal 200. Highly beneficially also, it is possible thus to have a first person dedicated to the configuration of the network and/or to the definition of the calendars and a second person, on site and having available a removable data storage means, who takes care of transferring these modifications in the network.

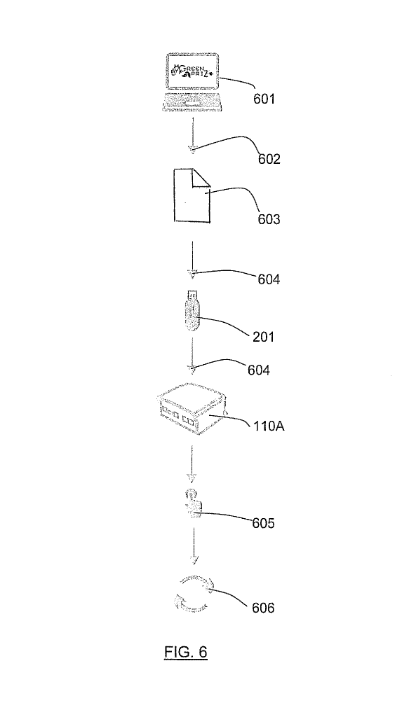

With reference to FIG. 6, the updating of calendars or network data will now be detailed.

At step 601, a user modifies, in dedicated software, here referred to as ‘MyGreenPriz’, at least one parameter of the network and at least one calendar.

At step 602, the file 603 containing these modifications is exported to a removable data storage means 201 such as a USB key. It should be noted at this stage that the creator of the update may be distant from the USB key. This is because the file 603 may be created from a terminal before being sent, for example by email, to another terminal or another user, who will then export this file 603 to the USB key.

At step 604, the removable data storage means 201 is then connected to the primary master socket 110A. In the case of a USB key, the latter is inserted in the host USB connector.

Step 605, which is optional, consists of activating a button present on the primary master socket 110A in order to trigger the taking into account of the files 603 of modifications by the primary master socket 110A. An alternative would consist of providing for the insertion of the key in the primary master socket 110A to suffice to trigger the taking into account of the files 603 by the primary master socket 110A.

Step 606 illustrates the processing, by the primary master socket 110A, of the modifications and instructions included in the file 603. Thus the data stored in the key update all or part of the network and/or the new calendars are taken into account. These calendars can then be propagated from the primary master socket 110A to the other sockets in the network, as detailed previously.

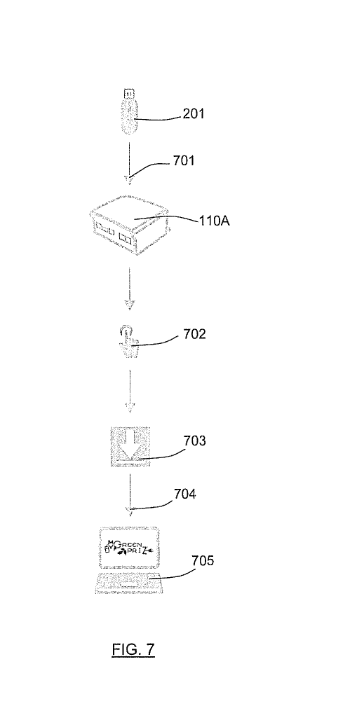

With reference to FIG. 7, the recovery of the consumption data from the network will now be detailed.

At step 701, the removable data storage means 201 is connected to the primary master socket 110A.

Step 702, which is optional, consists of activating a button present on the primary master socket 110A in order to trigger the recovery of the consumption data and to transfer them to the removable data storage means 201. An alternative would consist of providing for the insertion of the key in the primary master socket 110A to suffice to trigger the recovery of the consumption data and to transfer them onto the removable data storage means 201.

Step 703 illustrates the transfer of the consumption data from the primary master socket 110A to the removable data storage means 201. It will be understood that these consumption data come from a plurality of and preferably all the sockets in the network that depend on the primary master socket 110A. These data will either have been collected previously by the latter, or the collection thereof will have been triggered by the insertion of the removable data storage means 201 or by acting on the button at step 702.

The removable data storage means 201 is then removed from the primary master socket 110A and can be inserted in a user terminal as illustrated at step 704.

Step 708 illustrates the processing of the consumption data from or by a user terminal.

These two embodiments illustrate clearly the advantages in terms of simplification of the equipment and freedom of use afforded by a primary master socket 110A provided with a port for communication with a removable data storage means 201.

The invention is not limited to the embodiments previously described but extends to any embodiment in accordance with the spirit thereof.

1. Electrical supply system for electrical apparatus, comprising at least one master electrical socket, referred to as the primary master socket, able to be connected between an electrical supply source and at least one electrical apparatus, wherein the primary master socket comprises connection means to a user terminal and/or to a removable data storage means configured so as to receive a plurality of computerised calendars, data storage means, able to store the plurality of computerised calendars, transmission means configured so as to transmit at least one computerised calendar to another electrical socket, the primary master socket further comprising control means associated with a processor and configured so as to enable or interrupt the supply to the electrical apparatus able to be connected to the primary master socket according to a computerised calendar stored in the data storage means.

2. Electrical supply system according to claim 1, wherein said other electrical socket is a master socket, referred to as the secondary master socket, able to be connected between an electrical supply source and at least one electrical apparatus, the secondary master socket comprising reception means configured so as to receive at least one computerised calendar sent by a primary master socket, data storage means able to store at least one computerised calendar received and control means associated with a processor and configured so as to enable or interrupt the supply to the electrical apparatus connected to the secondary master socket according to a computerised calendar stored in the data storage means of this secondary master socket.

3. Electrical supply system according to claim 2, in which the data storage means of the primary master socket contain a first calendar for this primary master socket and at least a second calendar for a secondary master socket.

4. Electrical supply system according to claim 2, comprising at least one slave socket able to be connected between an electrical supply source and an electrical apparatus, the slave socket comprising reception means configured so as to receive, from a primary master socket or a secondary master socket, a command for activating or interrupting the electrical supply of the electrical apparatus.

5. Electrical supply system according to claim 4, wherein the master socket is a primary master socket.

6. Electrical supply system according to claim 4, in which the master socket is a secondary master socket, the secondary master socket comprising means for transmitting said command to the slave socket.

7. Electrical supply system according to claim 1, wherein at least one socket comprises an electricity consumption reading module configured to read the electricity consumption of the apparatus connected to said socket.

8. Electrical supply system according to claim 7, wherein said other electrical socket is a master socket, referred to as the secondary master socket, able to be connected between an electrical supply source and at least one electrical apparatus, the secondary master socket comprising reception means configured so as to receive at least one computerised calendar sent by a primary master socket, data storage means able to store at least one computerised calendar received and control means associated with a processor and configured so as to enable or interrupt the supply to the electrical apparatus connected to the secondary master socket according to a computerised calendar stored in the data storage means of this secondary master socket, further comprising at least one slave socket able to be connected between an electrical supply source and an electrical apparatus, the slave socket comprising reception means configured so as to receive, from a primary master socket or a secondary master socket, a command for activating or interrupting the electrical supply of the electrical apparatus, in which the slave socket is configured so as to transmit, to at least one primary master socket, electricity consumption data recorded by the reading module of this slave socket.

9. Electrical supply system according to claim 7, wherein said other electrical socket is a master socket, referred to as the secondary master socket, able to be connected between an electrical supply source and at least one electrical apparatus, the secondary master socket comprising reception means configured so as to receive at least one computerised calendar sent by a primary master socket, data storage means able to store at least one computerised calendar received and control means associated with a processor and configured so as to enable or interrupt the supply to the electrical apparatus connected to the secondary master socket according to a computerised calendar stored in the data storage means of this secondary master socket, wherein the secondary master socket is configured so as to transmit, to at least one primary master socket, electricity consumption data recorded by the reading module of this secondary master socket.

10. Electrical supply system according to claim 7, wherein the primary master socket is configured so as to transmit the electricity consumption data to a user terminal.

11. Electrical supply system according to claim 7, wherein said connection means of the primary master socket comprise at least one port for communication with a removable data storage means and wherein the primary master socket is configured so as to transmit the electricity consumption data to a removable data storage means.

12. Electrical supply system according to claim 1, wherein at least one socket comprises means for forcing electrical activation, these forcing means being able to be actuated by a user.

13. Electrical supply system according to claim 11, wherein at least one socket can be configured by a user according to several activation prolongation modes.

14. Electrical supply system according to claim 1, wherein at least one socket comprises a signalling means configured so as to signal an imminent deactivation of the electrical supply.

15. Electrical supply system according to claim 1, wherein each socket comprises reception and transmission means configured so as to transmit and receive data to/from remote master sockets.

16. Electrical supply system according to claim 1, wherein at least one master socket comprises a time reference stage configured so as to maintain a synchronisation of the date and time of this master socket with the user terminal.

17. Electrical supply system according to claim 1, wherein the connection means of at least one primary master socket comprise a connection port for connection with a user terminal in order to receive said plurality of computerised calendars.

18. Electrical supply system according to claim 1, wherein the connection means of at least one primary master socket comprise a connection port for connection with a removable data storage means in order to receive said plurality of computerised calendars.

19. Modular electrical supply system for electrical apparatus, comprising at least one master socket referred to as a secondary master socket, able to be connected between an electrical supply source and at least one electrical apparatus, wherein the secondary master socket comprises: reception means configured so as to receive at least one computerised calendar; data storage means able to store the at least one computerised calendar; control means associated with a processor and configured so as to enable or interrupt the supply to the electrical apparatus to which the secondary master socket is able to be connected according to at least one computerised calendar stored in the data storage means.

20. Electrical supply system according to claim 19, wherein the secondary master socket is configured so as to store at least one computerised calendar relating to a slave socket and to send to this slave socket a command to activate or interrupt the electrical supply to an electrical apparatus able to be connected to this slave socket according to the computerised calendar relating to this slave socket.

21. Electrical supply system according to claim 20, comprising at least one slave socket able to be connected between an electrical supply source and an electrical apparatus, comprising reception means configured so as to receive, from the secondary master socket, a command to activate or interrupt the electrical supply.

22. Electrical supply system according to claim 19, comprising a transmission module comprising: connection means to a user terminal and/or to a removable data storage means, these connection means being configured so as to receive a plurality of computerised calendars; transmission means configured so as to transmit at least one computerised calendar to the secondary master socket.

23. Electrical supply system according to claim 22, wherein the secondary master socket and the transmission module are distant.

24. Electrical supply system according to claim 23, wherein the transmission module is a so-called primary master socket, able to be connected between an electrical supply source and at least one electrical apparatus, the primary master socket comprising: data storage means able to store the plurality of computerised calendars received from the user terminal or from the removable data storage means; transmission means configured so as to transmit at least one computerised calendar to the secondary master socket; control means associated with a processor and configured so as to enable or interrupt the supply to the electrical apparatus to which the primary master socket is connected according to a computerised calendar stored in the data storage means.

25. Method for managing a plurality of sockets forming part of an electrical supply system for electrical apparatus, each socket being electrically connected between an electrical supply source and at least one electrical apparatus, the method being wherein it comprises the transmission of at least one computerised calendar from a primary master socket belonging to the plurality of sockets to another socket among the plurality of sockets, a calendar defining ranges of activation/deactivation of an electrical apparatus with respect to the electrical supply.

26. Method according to claim 25, wherein the at least one computerised calendar is transmitted from a primary master socket to a secondary master socket belonging to the plurality of sockets and wherein the at least one computerised calendar is stored in data storage means of the secondary master socket.

27. Method according to claim 26, wherein the at least one computerised calendar relates to the secondary master socket and wherein this secondary master socket activates or deactivates the electrical supply to the electrical apparatus to which it is connected according to said computerised calendar.

28. Method according to claim 26, wherein the at least one computerised calendar relates to a slave socket and wherein the secondary master socket sends to the slave socket a command to activate or interrupt the electrical supply according to said computerised calendar.

29. Method according to claim 25, wherein the primary master socket transmits an activation or deactivation command to a slave socket of the electrical supply system.

30. Method according to claim 28, wherein the slave socket, on receiving said command, activates the electrical supply of the electrical apparatus if the command is an activation command or deactivates the electrical supply to the electrical apparatus if the command is a deactivation command.

31. Method according to claim 25, comprising a step of storing a plurality of computerised calendars in the storage means of the primary master socket and comprising, before the storage step, a step of transmitting computerised calendars from a user terminal connected to the primary master socket or from a removable data storage means connected to the primary master socket.

32. Method according to claim 25, comprising a step of transferring electricity consumption data from the electrical apparatus to the primary master socket.

33. Method according to claim 32, wherein the electricity consumption data are transmitted from the primary master socket to a user terminal connected to said primary master socket or to a removable data storage means connected to the primary master socket.
